(19) United States
(12) Patent Application Publication
(10) Pub. No.: US 2024/0104488 A1
(43) Pub. Date: Mar. 28, 2024

(54) DELIVERY SUPPORT APPARATUS

(71) Applicant: TOYOTA JIDOSHA KABUSHIKI KAISHA, Toyota-shi (JP)

(72) Inventors: Hiroto TOMIDA, Tokyo-to (JP); Ryosuke KOBAYASHI, Nagakute-shi (JP); Satoshi KOMAMINE, Nagoya-shi (JP); Tetsuya IDE, Tokyo-to (JP); Mayuko ABE, Tokyo-to (JP); Makoto AKAHANE, Yokohama-shi (JP); Haruki OGURI, Toyota-shi (JP)

(73) Assignee: TOYOTA JIDOSHA KABUSHIKI KAISHA, Toyota-shi (JP)

(21) Appl. No.: 18/469,558

(22) Filed: Sep. 19, 2023

(30) Foreign Application Priority Data
Sep. 27, 2022 (JP) 2022-154221

(51) Int. Cl. G06Q 10/0833; G06Q 10/0832

(52) U.S. Cl. CPC G06Q 10/0833; G06Q 10/0832

(57) ABSTRACT

A delivery support apparatus according to the present disclosure includes a controller configured to acquire information about a vehicle used for delivery of a package, the information having been acquired on the vehicle, determine, based on the information about the vehicle, a loading/unloading location at which the package was loaded or unloaded, and generate, based on the loading/unloading location, information about a location at which packages can be loaded/unloaded.

### CROSS-REFERENCE TO RELATED APPLICATION

This application claims priority to Japanese Patent Application No. 2022-154221, filed on Sep. 27, 2022, the entire contents of which are incorporated herein by reference.

### TECHNICAL FIELD

The present disclosure relates to a delivery support apparatus.

### BACKGROUND

Technology for supporting delivery by a vehicle is known. For example, Patent Literature (PTL) 1 discloses checking whether a delivery can be made by an autonomous vehicle based on whether the delivery destination area is included in a no-parking area as defined by the Road Traffic Act.

### CITATION LIST

### Patent Literature

PTL 1: JP 2018-124676 A

### SUMMARY

Demand exists for further improvement in the usefulness of technology for supporting delivery by a vehicle. For example, demand exists for more accurate determination of locations where a vehicle can load and unload packages.

It would be helpful to improve the usefulness of technology for supporting delivery by a vehicle.

A delivery support apparatus according to an embodiment of the present disclosure includes a controller configured to:
acquire information about a vehicle used for delivery of a package, the information having been acquired on the vehicle;
determine, based on the information about the vehicle, a loading/unloading location at which the package was loaded or unloaded; and
generate, based on the loading/unloading location, information about a location at which packages can be loaded/unloaded.

According to an embodiment of the present disclosure, the usefulness of technology for supporting delivery by a vehicle is improved.

### BRIEF DESCRIPTION OF THE DRAWINGS

In the accompanying drawings:

FIG. 1 is a block diagram illustrating a schematic configuration of a delivery support system according to an embodiment of the present disclosure;

FIG. 2 is a block diagram illustrating a schematic configuration of a vehicle;

FIG. 3 is a block diagram illustrating a schematic configuration of a server; and

FIG. 4 is a flowchart illustrating operations of the delivery support system.

### DETAILED DESCRIPTION

Hereinafter, an embodiment of the present disclosure will be described.

### Outline of Embodiment

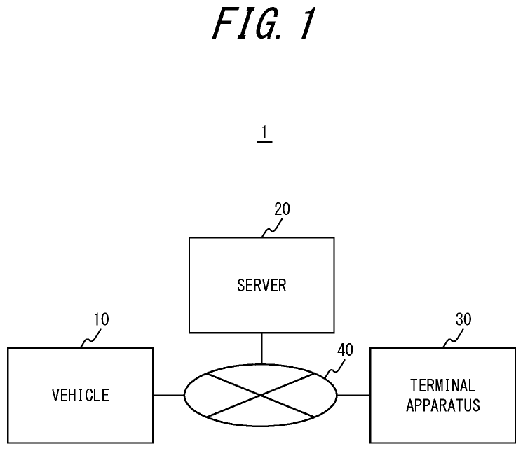

With reference to FIG. 1, a delivery support system 1 according to an embodiment of the present disclosure will be described. FIG. 1 is a block diagram illustrating a schematic configuration of the delivery support system 1. The delivery support system 1 includes a vehicle 10, a server 20, and a terminal apparatus 30.

The vehicle 10 is a vehicle, such as a truck, used for delivery of packages. However, the vehicle 10 is not limited to trucks and may be any vehicle usable for package delivery, such as a passenger car or a motorcycle. The vehicle 10 may be driven by a driver, or the driving may be automated or performed by remote control. The automation level is, for example, any one of Level 1 to Level 5 according to the level classification defined by the Society of Automotive Engineers (SAE).

The server 20 is configured by one or more computers. In the present embodiment, the server 20 will be described as being configured by a single computer. However, the server 20 may be configured by a plurality of computers that can communicate with each other, such as a cloud computing system.

The terminal apparatus 30 is, for example, a smartphone, but is not limited thereto and may be any computer, such as a personal computer or a tablet.

For the sake of simplicity, one each of the vehicle 10, the server 20, and the terminal apparatus 30 are illustrated in FIG. 1. However, the delivery support system 1 may include any number of vehicles 10, servers 20, and terminal apparatuses 30. The vehicles 10, the server 20, and the terminal apparatus 30 are communicably connected to a network 40 including, for example, the Internet, a mobile communication network, or the like.

First, an outline of the present embodiment will be described, and details thereof will be described later. The delivery support system 1 is, for example, used to support delivery by the vehicle 10. The server 20, which is a delivery support apparatus, acquires information about the vehicle 10 used for delivery of packages, the information having been acquired on the vehicle 10. The server 20 determines, based on the information about the vehicle 10, a loading/unloading location at which a package was loaded or unloaded. The server 20 generates, based on the loading/unloading location, information about a location at which packages can be loaded/unloaded.

In this way, according to the present embodiment, the locations at which the vehicle 10 can be stopped to load/unload packages can be determined based on actual past deliveries made using the vehicle 10. Therefore, the usefulness of technology for supporting delivery by the vehicle 10 is improved in that locations at which packages can be loaded/unloaded can be determined more accurately.

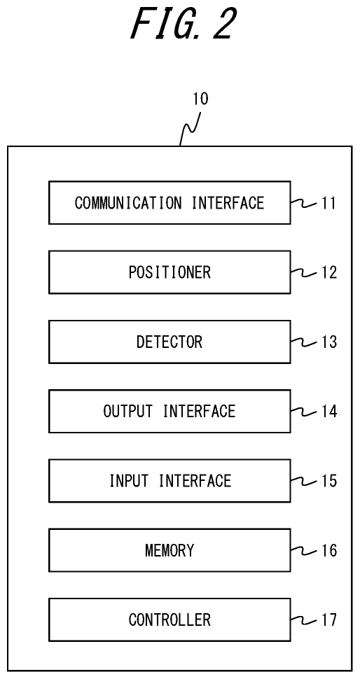

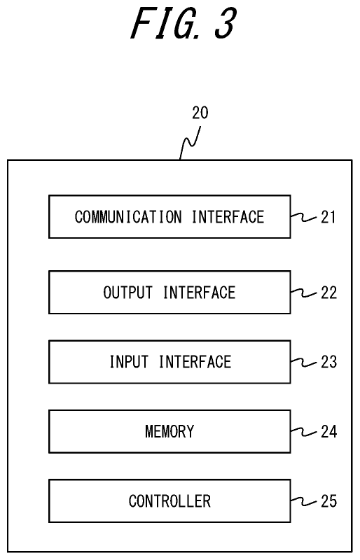

Next, with reference to FIGS. 2 and 3, configurations of the delivery support system 1 will be explained in detail. FIG. 2 is a block diagram illustrating a schematic configuration of the vehicle 10. FIG. 3 is a block diagram illustrating a schematic configuration of the server 20.

(Configuration of Vehicle)

As illustrated in FIG. 3, the vehicle 10 includes a communication interface 11, a positioner 12, a detector 13, an output interface 14, an input interface 15, a memory 16, and a controller 17. The communication interface 11, the positioner 12, the detector 13, the output interface 14, the input interface 15, the memory 16, and the controller 17 are communicably connected to each other via an in-vehicle network, such as a Controller Area Network (CAN), or a dedicated line.

The communication interface 11 includes a communication module for connecting to the network 40. The communication module is, for example, a communication module compliant with a mobile communication standard such as the 4th Generation (4G) standard or the 5th Generation (5G) standard. The communication module may be, for example, a communication module compliant with a standard such as a wired Local Area Network (LAN) standard or a wireless LAN standard. The communication module may be a communication module compliant with a short-range wireless communication standard such as Wi-Fi® (Wi-Fi is a registered trademark in Japan, other countries, or both), Bluetooth® (Bluetooth is a registered trademark in Japan, other countries, or both), or an infrared communication standard. In the present embodiment, the vehicle 10 is connected to the network 40 via the communication interface 11. This enables the vehicle 10 to communicate with the server 20 or the like.

The positioner 12 includes one or more positioning apparatuses capable of generating positional information for the vehicle 10. Positional information for the vehicle 10 is, for example, coordinates such as the two-dimensional coordinates or three-dimensional coordinates of the location of the vehicle 10. The positional information for the vehicle 10 may include the date and time at which the information was generated.

The positioner 12 may also generate the positional information for the vehicle 10 by navigation using a satellite positioning system, autonomous navigation, or a combination thereof. To generate the positional information for the vehicle 10 by navigation using a satellite positioning system, the positioner 12 may include a receiver compatible with a satellite positioning system such as the Global Positioning System (GPS). To generate the positional information for the vehicle 10 by autonomous navigation, the positioner 12 may include a sensor such as an acceleration sensor or a gyro sensor.

The detector 13 includes one or more sensors capable of generating information about the vehicle 10. For example, the detector 13 may include a first detector 13A or a second detector 13B.

The first detector 13A is configured to generate opening/closing information on a door of the vehicle 10. The first detector 13A includes, for example, a displacement sensor, a contact sensor, an infrared sensor, or an illumination sensor, though these examples are not limiting. In the present disclosure, the door of the vehicle 10 is a door that may be used for loading and unloading packages onto and off the vehicle 10. For example, the door of the vehicle 10 may be the door to the storage compartment of the vehicle 10. The opening/closing information on the door of the vehicle 10 is information indicating whether the door of the vehicle 10 is open or closed. The opening/closing information on the door of the vehicle 10 may include the date and time the door was opened or the date and time the door was closed.

The second detector 13B is configured to generate load information on the amount of packages in the vehicle 10. The load information on the amount of packages in the vehicle 10 may be information indicating the weight, volume, number, or the like of packages loaded onto the vehicle 10. For example, as information indicating the weight of the packages, the load information may include the weight of the packages loaded onto the vehicle 10 or may include information from which the weight of the packages loaded on the vehicle 10 can be calculated, such as the weight of the storage compartment of the vehicle or the weight of the vehicle 10. The second detector 13B may include a weight sensor or the like to generate the information indicating the weight of the packages. As another example, the load information can include the volume of the area occupied by the packages in the storage compartment of the vehicle as information indicating the volume of the packages. The second detector 13B may include a camera, such as an image sensor or infrared sensor, to generate the information indicating the volume of the packages. As yet another example, the load information can include the number of electronic tags or codes attached to each package as information indicating the number of packages. The second detector 13B may include a reader for electronic tags, codes, or the like to generate information indicating the number of packages. However, the load information on the amount of packages in the vehicle 10 is not limited to the information described above and may include any information that can indicate the amount of packages. The load information on the amount of packages in the vehicle 10 may include the date and time at which the information was generated.

The output interface 14 includes at least one output apparatus. The output apparatus included in the output interface 14 is, for example, a display, a speaker, a lamp, or the like. The output interface 14 outputs images, sound, light, or the like.

The input interface 15 includes at least one input apparatus. The input apparatus included in the input interface 15 may, for example, be a touch panel, a camera, a microphone, or the like. The input interface 15 accepts input operations from a user.

The memory 16 is, for example, a semiconductor memory, a magnetic memory, an optical memory, or the like. The memory 16 may function as, for example, a main memory, an auxiliary memory, or a cache memory. The memory 16 stores any data used for the operations of the vehicle 10. For example, the memory 16 stores a system program, an application program, embedded software, or the like. The information stored in the memory 16 may be updated with, for example, information acquired from the network 40 via the communication interface 11.

The controller 17 includes at least one processor. The processor may be, for example, a general purpose processor such as a Central Processing Unit (CPU), a dedicated processor that is dedicated to specific processing, or the like. The controller 17 is not limited to a processor and may include at least one dedicated circuit. Examples of dedicated circuits may include a Field-Programmable Gate Array (FPGA) and an Application Specific Integrated Circuit (ASIC). The controller 17 controls the above-described components such as the communication interface 11, the positioner 12, the detector 13, the output interface 14, the input interface 15, and the memory 16 to realize the functions of the vehicle 10, including the functions of these components. The controller 17 may, for example, be an Electronic Control Unit (ECU) of the vehicle 10.

(Configuration of Server)

As illustrated in FIG. 3, the server 20 includes a communication interface 21, an output interface 22, an input interface 23, a memory 24, and a controller 25. The communication interface 21, the output interface 22, the input interface 23, the memory 24, and the controller 25 are communicably connected to each other in a wired or wireless manner.

The communication interface 21 includes a communication module for connecting to the network 40. The communication module is, for example, a communication module compliant with a mobile communication standard such as the 4G standard or the 5G standard. The communication module may be, for example, a communication module compliant with a standard such as a wired LAN standard or a wireless LAN standard. The communication module may be a communication module compliant with a short-range wireless communication standard such as Wi-Fi®, Bluetooth®, or an infrared communication standard. In the present embodiment, the server 20 is connected to the network 40 via the communication interface 21. This enables the server 20 to communicate with the vehicle 10, the terminal apparatus 30, and the like.

The output interface 22 includes at least one output apparatus. The output apparatus included in the output interface 22 is, for example, a display, a speaker, a lamp, or the like. The output interface 22 outputs images, sound, light, or the like.

The input interface 23 includes at least one input apparatus. The input apparatus included in the input interface 23 may, for example, be a touch panel, a camera, a microphone, or the like. The input interface 23 accepts input operations from a user.

The memory 24 is, for example, a semiconductor memory, a magnetic memory, an optical memory, or the like. The memory 24 may function as, for example, a main memory, an auxiliary memory, or a cache memory. The memory 24 stores any information used for operations of the server 20. For example, the memory 24 stores a system program, an application program, embedded software, or the like. The information stored in the memory 24 may be updated with, for example, information acquired from the network 40 via the communication interface 21.

The controller 25 includes at least one processor. The processor may be, for example, a general purpose processor such as a CPU, a dedicated processor that is dedicated to specific processing, or the like. The controller 25 is not limited to a processor and may include at least one dedicated circuit. Examples of the dedicated circuit include an FPGA and an ASIC. The controller 25 controls the above-described components such as the communication interface 21, the output interface 22, the input interface 23, and the memory 24 to realize the functions of the server 20, including the functions of these components.

(Operations of Delivery Support System)

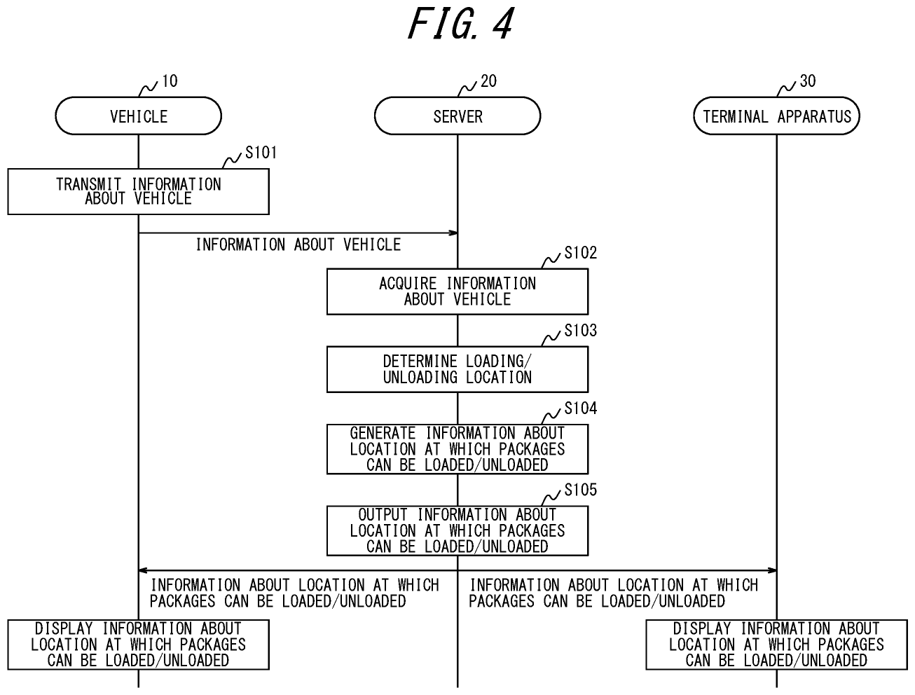

Operations of the delivery support system 1 will be described with reference to FIG. 4. FIG. 4 is a flowchart illustrating operations of the delivery support system 1. The flowchart in FIG. 4 illustrates the operation of the vehicle 10, the server 20, and the terminal apparatus 30 included in the delivery support system 1. Therefore, the description of these operations corresponds to a control method for the delivery support system 1, and also corresponds to a control method for each of the vehicle 10, the server 20, and terminal apparatus 30 included in the delivery support system 1.

In step S101, the controller 17 of the vehicle 10 transmits the information about the vehicle 10, acquired on the vehicle 10, to the server 20 via the communication interface 11.

The controller 17 of the vehicle 10 generates information about the vehicle 10 using the positioner 12 or the detector 13. The information about the vehicle 10 may, for example, include positional information for the vehicle 10 as generated by the positioner 12, opening/closing information on the door of the vehicle 10 as generated by the first detector 13A, or load information on the amount of packages in the vehicle 10 as generated by the second detector 13B. The information about the vehicle 10 is not, however, limited to the above-described information and may include information such as a log of the controller 17 controlling each function of the vehicle 10. The information about the vehicle 10 may be probe data. The controller 17 may transmit the information about the vehicle 10 via the communication interface 11 repeatedly in cycles or at arbitrary times. In the present embodiment, the information about the vehicle 10 acquired on the vehicle 10 is described as being transmitted directly from the vehicle 10 to the server 20. However, the information about the vehicle 10 acquired on the vehicle 10 may be transmitted indirectly from the vehicle 10 to the server 20 via a data collection service or the like.

In step S102, the controller 25 of the server 20 acquires, via the communication interface 21, the information about the vehicle 10 used for delivery of packages, the information having been acquired on the vehicle 10. The controller 25 may store the acquired information about the vehicle 10 in the memory 24.

In step S103, the controller 25 of the server 20 determines, based on the information about the vehicle 10, a loading/unloading location at which a package was loaded or unloaded. The loading/unloading location includes the location at which the package was loaded onto the vehicle 10 or the location at which the package was unloaded from the vehicle 10.

Any method can be employed to determine the loading/unloading location. As a first determination method, the controller 25 of the server 20 can determine, based on the positional information for the vehicle 10 included in the information about the vehicle 10, that the vehicle 10 stopped and the package was loaded or unloaded in a case in which the coordinates of the location of the vehicle 10 did not move for a predetermined amount of time or longer. The controller 25 may thereby determine the location at which the vehicle 10 stopped for a predetermined amount of time or longer as the loading/unloading location based on the positional information for the vehicle 10. The predetermined amount of time is, for example, 10 minutes, but this example is not limiting.

As a second determination method, the controller 25 of the server 20 can determine, based on the opening/closing information on the door of the vehicle 10 included in the information about the vehicle 10, that the package was loaded or unloaded in a case in which the door of the vehicle 10 was opened. The controller 25 may thereby determine the location at which the door of the vehicle 10 was opened as the loading/unloading location based on the opening/closing information on the door of the vehicle 10.

As a third determination method, the controller 25 of the server 20 can determine, based on the load information on the amount of packages in the vehicle 10 included in the information about the vehicle 10, that the package was loaded or unloaded in a case in which the amount (weight, volume, number, or the like) of packages loaded onto the vehicle 10 changed. The controller 25 may thereby determine the location at which the amount of packages loaded onto the vehicle 10 changed as the loading/unloading location based on the load information on the amount of packages in the vehicle 10.

In the present embodiment, in step S103, the controller 25 of the server 20 determines the loading/unloading location based on information about the vehicle 10 using at least one of the three determination methods described above. For example, based on the information about the vehicle 10, the controller 25 may determine a location at which the vehicle 10 stopped for a predetermined amount of time or longer, the door of the vehicle 10 was opened, and the amount of packages loaded on the vehicle 10 changed as the loading/unloading location. Such a combination of a plurality of determination methods can prevent false detection of loading/unloading locations and improves the determination accuracy of the loading/unloading locations. For example, based on the information about the vehicle 10, the controller 25 may determine a location at which the vehicle 10 stopped for a predetermined amount of time or longer and the door of the vehicle 10 was opened as the loading/unloading location. Alternatively, based on the information about the vehicle 10, the controller 25 may determine a location at which the vehicle 10 stopped for a predetermined amount of time or longer and the amount of packages loaded on the vehicle 10 changed as the loading/unloading 1 ocation. Based on the information about the vehicle 10, the controller 25 may determine a location at which the door of the vehicle 10 was opened and the amount of packages loaded on the vehicle 10 changed as the loading/unloading location. The determination accuracy of loading/unloading locations can thereby be improved while reducing the processing load pertaining to the determination process.

In step S103, the controller 25 of the server 20 may further determine, based on the information about the vehicle 10, a loading/unloading failure location at which a package was not loaded or unloaded. Specifically, the controller 25 may determine the loading/unloading failure location based on information about the vehicle 10 using at least one of the three determination methods described above. For example, based on the information about the vehicle 10, the controller 25 may determine a location at which the vehicle 10 stopped for less than a predetermined amount of time as the loading/unloading failure location. For example, based on the information about the vehicle 10, the controller 25 may determine a location at which the vehicle 10 stopped for a predetermined amount of time or longer but the door of the vehicle 10 was not opened as the loading/unloading failure location. Based on the information about the vehicle 10, the controller 25 may determine a location at which the vehicle 10 stopped for a predetermined amount of time or longer but the amount of packages loaded on the vehicle 10 did not change as the loading/unloading failure location. Alternatively, based on the information about the vehicle 10, the controller 25 may determine a location at which the door of the vehicle 10 was opened but the amount of packages loaded on the vehicle 10 did not change as the loading/unloading failure location.

In step S104, the controller 25 of the server 20 generates, based on the loading/unloading location, information about a location at which packages can be loaded/unloaded.

Specifically, the controller 25 of the server 20 stores information about the loading/unloading location determined in step S103 in the memory 24 as information about a location at which packages can be loaded/unloaded. The information about the loading/unloading location may, for example, include information such as the coordinates of the loading/unloading location, the time slot in which the loading/unloading took place, the stopping time, the type of package, and the type of vehicle 10. The information about a location at which packages can be loaded/unloaded may include information about the loading/unloading locations of a plurality of vehicles 10. In a case in which information about a location at which packages can be loaded/unloaded has already been stored in the memory 24, the controller 25 may add the information about the loading/unloading location determined in step S103 to the stored information. In this way, according to the present embodiment, the locations at which the vehicle 10 can be stopped to load/unload packages can be determined accurately based on actual loading/unloading during past deliveries.

In step S104, the controller 25 of the server 20 may further generate, based on the loading/unloading location and the loading/unloading failure location, information about a location at which packages can be loaded/unloaded. The controller 25 may store information about the loading/unloading location and information about the loading/unloading failure location determined in step S103 in a distinguishable manner in the memory 24 as information about a location at which packages can be loaded/unloaded. The information about the loading/unloading failure location may, for example, include information such as the coordinates of the loading/unloading failure location, the time slot in which the loading/unloading did not take place, the stopping time, the type of package, and the type of vehicle 10. The locations at which the vehicle 10 can be stopped to load/unload packages can thereby be determined more accurately based on actual successes and actual failures in loading/unloading during past deliveries.

In step S105, the controller 25 of the server 20 outputs the information about the location at which packages can be loaded/unloaded.

Any method can be employed to output the information about the location at which packages can be loaded/unloaded. For example, the controller 25 of the server 20 may output the actual information about the location at which packages can be loaded/unloaded via the output interface 22, such as a display, or may transmit the information to the vehicle 10, the terminal apparatus 30, or the like via the communication interface 21. Alternatively, the controller 25 of the server 20 may generate a mapping image that maps the information about the location at which packages can be loaded/unloaded onto an image, such as a map, photo, or video. Loading/unloading locations may be mapped onto the mapping image. Alternatively, in addition to the loading/unloading locations, the loading/unloading failure locations may be mapped onto the mapping image in a distinguishable manner, for example by using different icons. The controller 25 may output the mapping image, as the information about the location at which packages can be loaded/unloaded, via the output interface 22, such as a display, or may transmit the mapping image to the vehicle 10, the terminal apparatus 30, or the like via the communication interface 21. This makes it easier for users of the delivery support system 1 to recognize more accurately the locations at which packages can be loaded/unloaded.

As described above, the server 20, which is a delivery support apparatus according to the present embodiment, acquires information about the vehicle 10 used for delivery of packages, the information having been acquired on the vehicle 10. The server 20 determines, based on the information about the vehicle 10, a loading/unloading location at which a package was loaded or unloaded. The server 20 generates, based on the loading/unloading location, information about a location at which packages can be loaded/unloaded.

According to this configuration, the locations at which the vehicle 10 can be stopped to load/unload packages can be determined based on actual past deliveries made using the vehicle 10. Therefore, the usefulness of technology for supporting delivery by the vehicle 10 is improved in that locations at which packages can be loaded/unloaded can be determined more accurately.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, in the above embodiment, all or some of the functions or processes described as the functions or processes of the server 20 may be realized as the functions or processes of the vehicle 10. Specifically, a program in which processes for realizing all or a portion of the functions or processes of the server 20 according to an embodiment are written may be stored in the memory 16 of the vehicle 10, and the program may be read and executed by the controller 17. Similarly, all or some of the functions or processes described as the functions or processes of the vehicle 10 may be realized as the functions or processes of the server 20.

For example, an embodiment in which a general purpose computer functions as the controller 17 of the vehicle 10 or the server 20 according to the above embodiment can also be implemented. Specifically, a program in which processes for realizing the functions of the controller 17 of the vehicle 10 or the server 20 according to the above embodiment are written may be stored in a memory of a general purpose computer, and the program may be read and executed by a processor. Accordingly, the present disclosure can also be implemented as a program executable by a processor, or a non-transitory computer readable medium storing the program. Examples of the non-transitory computer readable medium include a magnetic storage device, an optical disc, a magneto-optical storage device, and a semiconductor memory.

1. A delivery support apparatus comprising a controller configured to:
acquire information about a vehicle used for delivery of a package, the information having been acquired on the vehicle;
determine, based on the information about the vehicle, a loading/unloading location at which the package was loaded or unloaded; and
generate, based on the loading/unloading location, information about a location at which packages can be loaded/unloaded.

2. The delivery support apparatus according to claim 1, wherein
the information about the vehicle includes positional information for the vehicle, and
the controller is configured to determine, based on the positional information, a location at which the vehicle stopped for a predetermined amount of time or longer as the loading/unloading location.

3. The delivery support apparatus according to claim 1, wherein
the information about the vehicle includes opening/closing information on a door of the vehicle, and
the controller is configured to determine, based on the opening/closing information, a location at which the door of the vehicle was opened as the loading/unloading location.

4. The delivery support apparatus according to claim 1, wherein
the information about the vehicle includes load information on an amount of packages in the vehicle, and
the controller is configured to determine, based on the load information, a location at which the amount of packages loaded onto the vehicle changed as the loading/unloading location.

5. The delivery support apparatus according to claim 1, wherein the controller is configured to
determine, based on the information about the vehicle, a loading/unloading failure location at which the package was not loaded or unloaded, and
generate, based on the loading/unloading location and the loading/unloading failure location, the information about the location at which packages can be loaded/unloaded.
